(19) United States
(12) Patent Application Publication
(10) Pub. No.: US 2024/0291248 A1
(43) Pub. Date: Aug. 29, 2024

(54) UTILITY POLE

(71) Applicant: NIPPON TELEGRAPH AND TELEPHONE CORPORATION, Tokyo (JP)

(72) Inventors: Tatsuya MOKI, Musashino-shi, Tokyo (JP); Kenji INOUE, Musashino-shi, Tokyo (JP); Hidenobu HIROTA, Musashino-shi, Tokyo (JP); Yoshiyasu SATO, Musashino-shi, Tokyo (JP); Wataru KOKUBO, Musashino-shi, Tokyo (JP)

(73) Assignee: NIPPON TELEGRAPH AND TELEPHONE CORPORATION, Tokyo (JP)

(21) Appl. No.: 18/569,585

(22) PCT Filed: Jul. 5, 2021
(86) PCT No.: PCT/JP2021/025278

§ 371 Date: Dec. 12, 2023

(51) Int. Cl. H02G 1/02

(52) U.S. Cl. CPC H02G 1/02

(57) ABSTRACT

The present disclosure aims to reduce the weight of a utility pole.

The present disclosure provides a utility pole that is formed with an organic material, and has a plurality of holes penetrating between the outside space and the internal space, the plurality of holes being formed in part of the side surface of a cylindrical trapezoid that has a thin upper portion and a thick lower portion.

### TECHNICAL FIELD

The present disclosure relates to lightweight utility poles.

### BACKGROUND ART

A large number of utility poles have been built in Japan. They are built along a track (FIG. 1) to supply power to trains running on the railway, and on a road (FIG. 2) to provide power and communication to customers' homes. In FIGS. 1 and 2, reference numeral 10 indicates a utility pole, reference numeral 21 indicates a communication cable, and reference numeral 22 denotes a power cable. The number of utility poles built in Japan is 30 million or larger. Furthermore, about 50,000 to 100,000 utility poles are being newly built every year.

The number of workers is decreasing with the aging of workers who stand utility poles and the decrease in population. Since utility poles will continue to be built in the future, efficient pole construction techniques are required.

A structure of a standard utility pole that is currently adopted is now described. The materials include concrete and a steel material. Since a utility pole is to be built outdoors, the same materials as those of a structure such as a building are used. The steel material is formed into a columnar shape, and concrete is poured into the steel material while centrifugal separation is performed thereon, so that the center of the utility pole becomes hollow (see Non Patent Literatures 1 and 2, for example). FIG. 3 shows a cross-section perpendicular to the long axis direction of a utility pole. In FIG. 3, reference numeral 11 indicates a steel wire, reference numeral 12 indicates concrete, and reference numeral 13 indicates a hollow space. The periphery of the steel wire 11 is covered with the concrete 12, and the central portion is the hollow space 13.

### CITATION LIST

### Non Patent Literature

Non Patent Literature 1: Homepage of Dainichi Concrete Industry Co., Ltd. http://www.dainichi-x.co.jp/service/pole/Non
Patent Literature 2: “Studies on the influence of environmental conditions on aged degradation of prestressed concrete poles”, Proceedings of the JCI, pp. 381-1386, Vol. 36, No. 2, 2014

### SUMMARY OF INVENTION

### Technical Problem

Since a utility pole is a complex of concrete and a steel material, the weight of one utility pole exceeds one ton. Also, there are cases where the depth of a hole to be dug when a utility pole is built exceeds two meters, and a utility pole having a length of 10 meters or longer is built in the hole. The workers have to accurately insert the heavy and long structure into the hole. Accurate work is required to erect the utility pole straight. Before the utility pole is built, the utility pole is transported to the construction site by a vehicle. A heavy machine is used to lift up the utility pole from the vehicle and move the utility pole into the hole. Further, to accurately put the utility pole into the hole, the workers perform construction while communicating with the operator operating the heavy machine.

It is the weight of the utility pole that makes the construction work difficult. Since the utility pole is heavy, a large-size heavy machine must be used.

Therefore, to solve the above problem, the present disclosure aims to reduce the weight of a utility pole.

### Solution to Problem

To solve the above problem, a utility pole is formed with a lightweight material, and a plurality of holes that penetrate between the outside and the internal space of the utility pole is formed.

Specifically, the present disclosure provides
a utility pole that is formed with an organic material, and has a plurality of holes penetrating between the outside space and an internal space, the plurality of holes being formed in part of the side surface of a cylindrical trapezoid that has a thin upper portion and a thick lower portion.

In the utility pole according to the present disclosure,
the plurality of holes may be formed in an upper portion.

In the utility pole according to the present disclosure,
the area density of the plurality of holes may be higher in an upper portion than in a lower portion.

In the utility pole according to the present disclosure,
the number of holes per unit area among the plurality of holes may be constant, and the size of the plurality of holes may be larger in an upper portion than in a lower portion.

In the utility pole according to the present disclosure,
the sizes of the plurality of holes may be uniform, and the number of holes per unit area among the plurality of holes may be larger in an upper portion than in a lower portion.

In the utility pole according to the present disclosure,
some of the holes in an upper portion may be circular holes.

In the utility pole according to the present disclosure,
some of the holes in the upper portion may be circular holes of at least two different sizes.

### Advantageous Effects of Invention

According to the present disclosure, the weight of a utility pole can be reduced.

### BRIEF DESCRIPTION OF DRAWINGS

FIG. 1 is a photograph of utility poles.

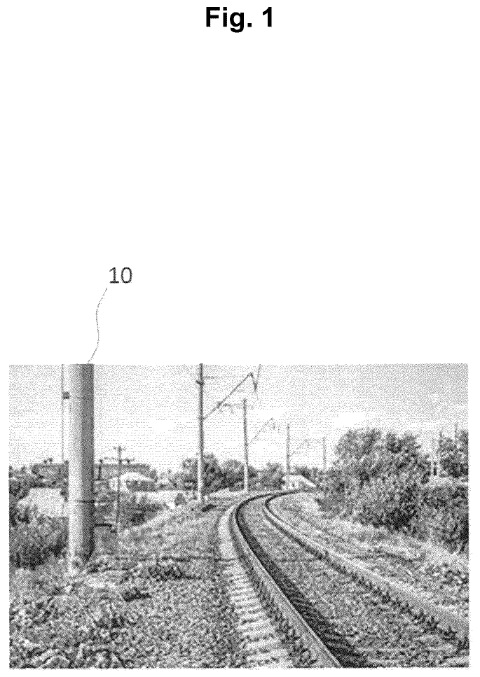

FIG. 2 is a photograph of a utility pole.

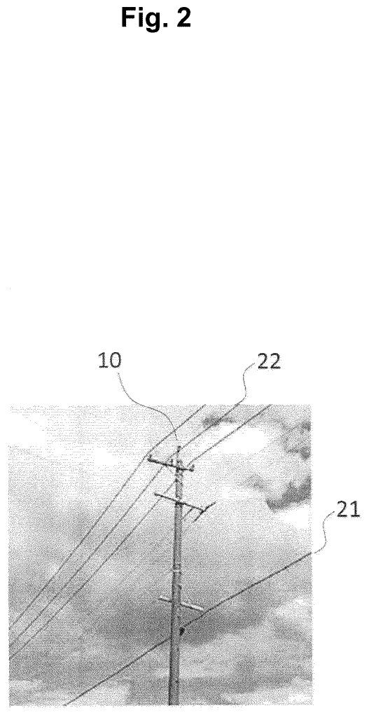

FIG. 3 is a cross-sectional view perpendicular to the long axis direction of a utility pole.

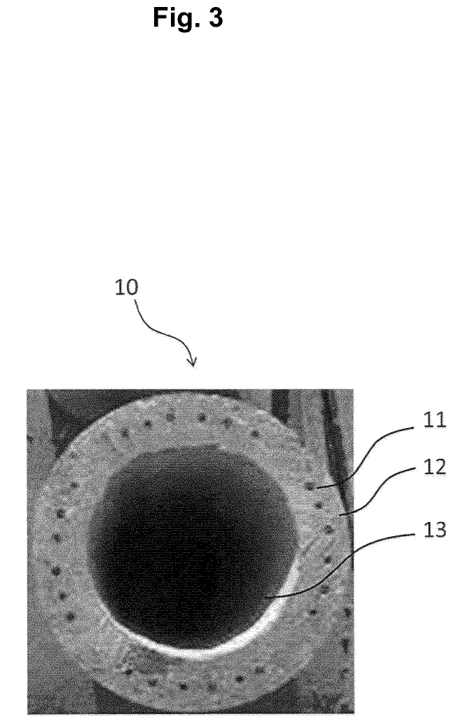

FIG. 4 is a diagram for roughly explaining the structure of a utility pole according to the present disclosure as viewed from a side.

FIG. 5A is an example of arrangement of a plurality of holes of a utility pole according to the present disclosure.

FIG. 5B is an example of arrangement of a plurality of holes of a utility pole according to the present disclosure.

FIG. 5C is an example of arrangement of a plurality of holes of a utility pole according to the present disclosure.

FIG. 6 is a diagram for illustrating a situation in which a utility pole according to the present disclosure is installed on the ground.

FIG. 7 is a diagram for roughly explaining the structure of a utility pole according to the present disclosure as viewed from a side.

FIG. 8 is a photograph for explaining a situation in which cables are suspended on a utility pole that is used at present.

FIG. 9 is a diagram for roughly explaining the structure of a utility pole according to the present disclosure as viewed from a side.

### DESCRIPTION OF EMBODIMENTS

The following is a detailed description of embodiments of the present disclosure, with reference to the drawings. Note that the present disclosure is not limited to the embodiments described below. These embodiments are merely examples, and the present disclosure can be carried out in forms with various modifications and improvements based on the knowledge of those skilled in the art. Note that components denoted by the same reference sign in the present specification and the drawings are the same.

### First Embodiment

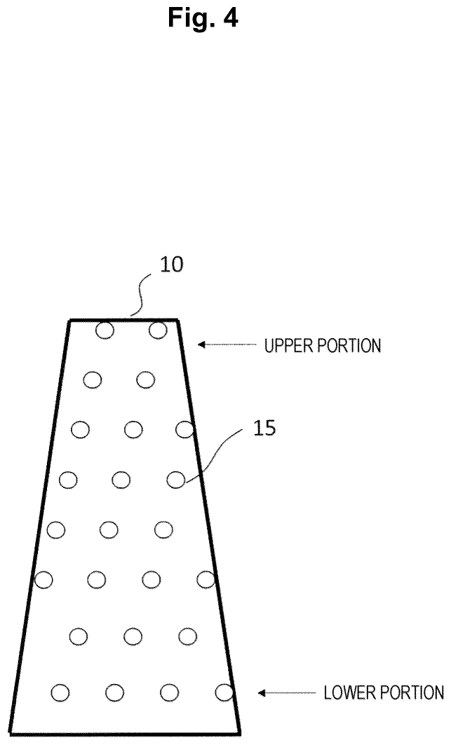

FIG. 4 schematically illustrates the structure of a utility pole according to the present disclosure as viewed from a side. In FIG. 4, reference numeral 10 indicates a utility pole, and reference numeral 15 indicates a hole. The utility pole 10 has a tapered cylindrical trapezoidal shape with a thin upper portion and a thick lower portion. At least part of the side surface is provided with a plurality of holes penetrating between the outside and the internal space. The plurality of holes may be provided in the entire side surface. As the plurality of holes is formed, the weight of the utility pole can be reduced. When the utility pole is formed with an organic material, the utility pole can be made even lighter in weight than a conventional concrete utility pole. The organic material may be plastic, for example. When the material is an organic material such as plastic, injection molding can be performed, and accordingly, the workability is higher than that with a concrete utility pole.

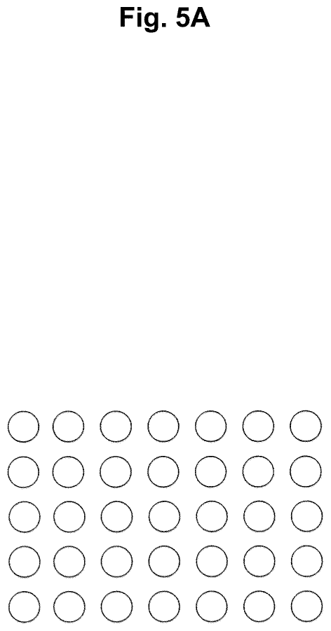

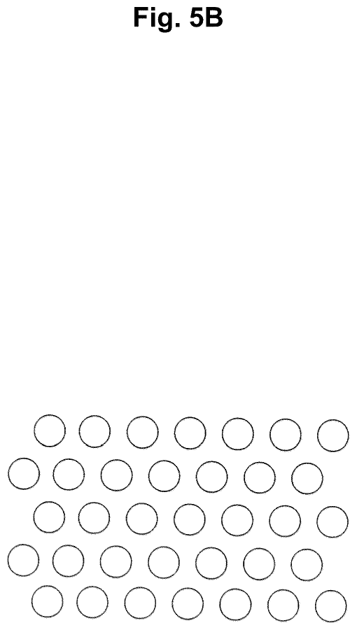

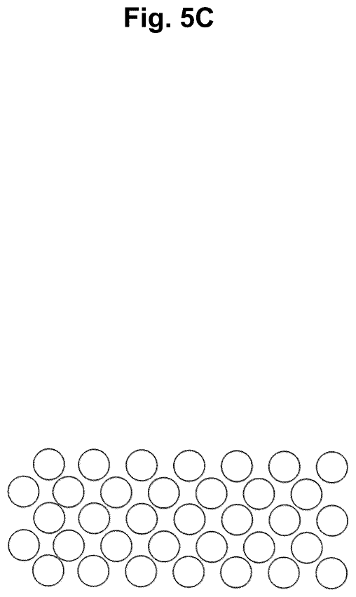

Examples of the shape of the holes include a circle, a square, a rectangle, a long circle, an ellipse, a hexagon, a cross, and any combination of these shapes. Examples of arrangement of the plurality of holes are shown in FIGS. 5A, 5B, and 5C. FIGS. 5A, 5B, and 5C illustrate a parallel arrangement (FIG. 5A), 60-degree staggered arrangement (FIG. 5B), and a 45-degree staggered arrangement (FIG. 5C), respectively, with the shape of the holes being a circle, for example. The shape and the arrangement of the holes are examples, and not limited to them.

### Second Embodiment

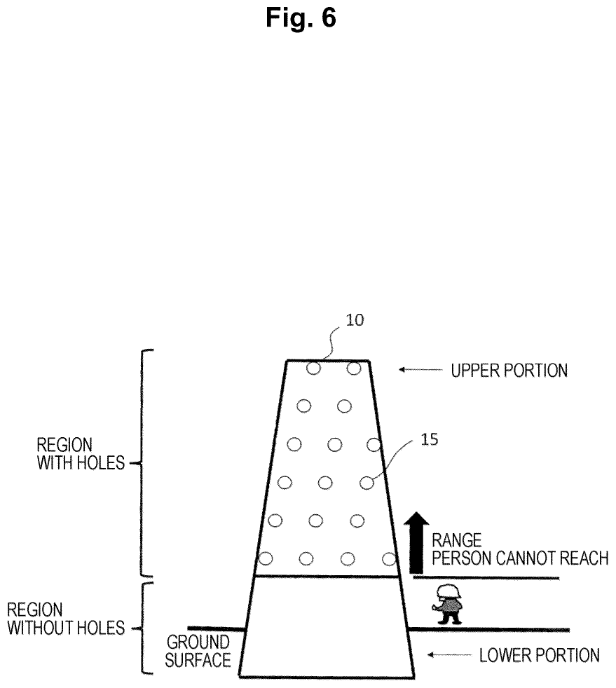

The plurality of holes is preferably formed in the upper portion of a utility pole. As illustrated in FIG. 4, any hole is not formed in the lower portion of the utility pole, and a plurality of holes is formed in the upper portion of the utility pole. FIG. 6 illustrates a situation in which the utility pole is installed on the ground. In FIG. 6, reference numeral 10 indicates the utility pole, and reference numeral 15 indicates the holes. In FIG. 6, a hole is dug in the ground, and the lower portion of the utility pole is put into the hole.

As the plurality of holes is not formed in the lower portion, it is possible to prevent soil of the ground from entering the holes. If soil of the ground enters the holes, the utility pole becomes unstable.

The holes are preferably formed in the upper portion of the utility pole so as to avoid the range that a person can reach after the pole construction. Holes formed in a range that a person can reach would be inappropriate in terms of hygiene and safety.

### Third Embodiment

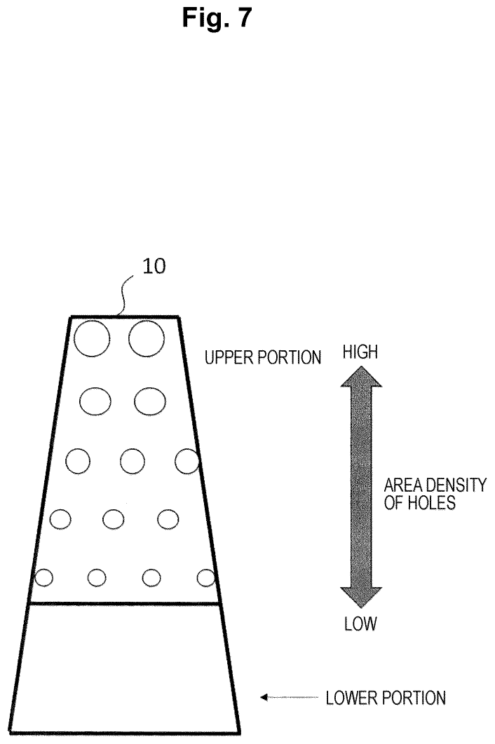

In the structure of a utility pole that is being used at present, the upper portion and the lower portion have different thicknesses, and the upper portion is thinner. To make the strength of the pole constant, a portion closer to the top is thinner. In a utility pole according to the present disclosure, the area density of the plurality of holes is preferably higher in the upper portion than in the lower portion. FIG. 7 schematically illustrates the structure of a utility pole according to the present disclosure as viewed from a side. As illustrated in FIG. 7, the area density of the plurality of holes is lower at a portion closer to the lower portion, and accordingly, the strength is higher at a portion closer to the lower portion.

To make the area density higher at a portion closer to the top of the utility pole, the size of each hole is made larger at a portion closer to the top than at a portion closer to the lower portion, in a case where the number of the holes per unit area is constant, for example. In a case where the sizes of the holes are uniform, the number of holes is made larger at a portion closer to the top than at a portion closer to the lower portion.

Where the area density is made higher at a portion closer to the top of the utility pole, it is easy to release the wind pressure that is applied to the utility pole by strong wind. As the wind pressure is lowered, the utility pole can be made thinner. Accordingly, the number of components can be reduced, and the weight of the utility pole can be further reduced.

### Fourth Embodiment

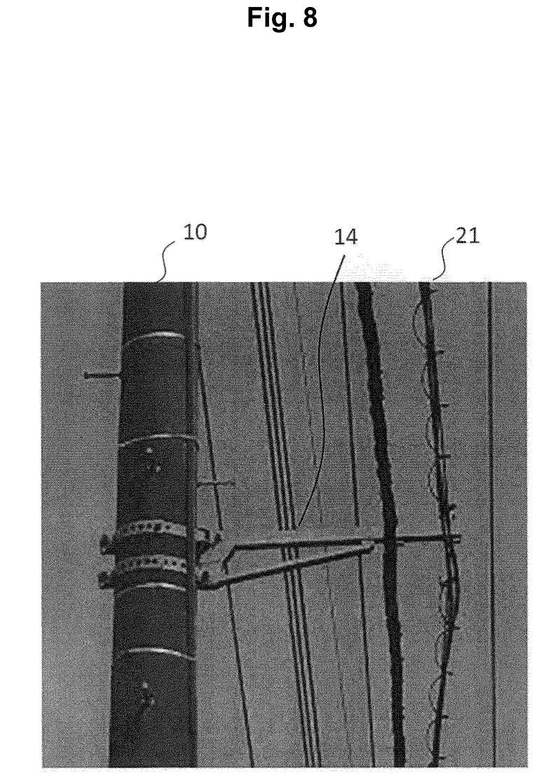

FIG. 8 illustrates a situation in which cables are suspended on a utility pole that is currently used. In FIG. 8, reference numeral 10 indicates a utility pole, reference numeral 14 indicates a metallic member, and reference numeral 21 indicates a communication cable. To suspend a cable on the utility pole, the metallic member 14 is installed on the utility pole 10, and the communication cable 21 is fixed to the metallic member 14.

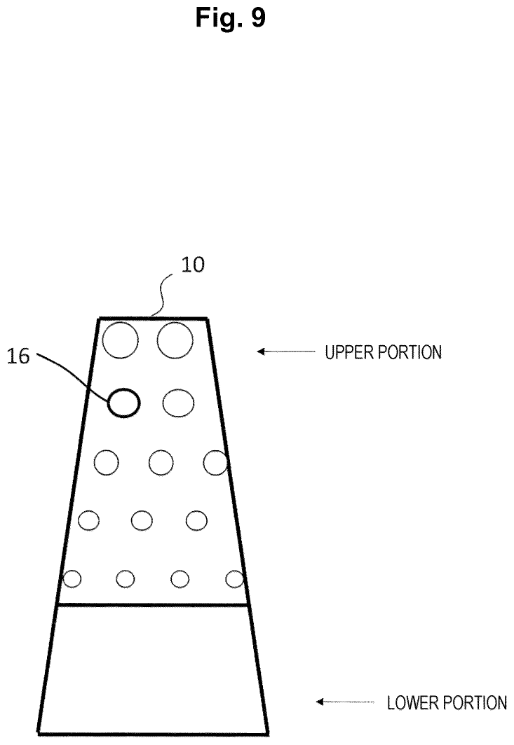

Some of the holes in the upper portion of the utility pole have a circular shape. For example, the shape of holes provided at the position where the communication cable 21 is to be attached to the utility pole is circular. FIG. 9 schematically illustrates the structure of a utility pole according to the present disclosure as viewed from a side. In FIG. 9, reference numeral 16 indicates a circular hole. Since the cross-sectional shapes of a communication cable and a power cable are circular, the shape of the holes is also circular in accordance with the shape. A communication cable and a power cable are inserted through the holes, so that the communication cable and the power cable are suspended on the utility pole. As a result, the metallic member illustrated in FIG. 8 becomes unnecessary.

Communication cables and power cables have different thicknesses, depending on purposes of use. Holes of two or more different sizes are formed in the upper portion of the utility pole, it is possible to suspend a wide variety of cables on the same utility pole.

As described so far, the present disclosure can reduce the weight of a utility pole.

### INDUSTRIAL APPLICABILITY

The present disclosure can be applied to communications industries.

### REFERENCE SIGNS LIST

10 utility pole
11 steel wire
12 concrete
13 hollow space
14 metallic member
15 hole
16 circular hole
21 communication cable
22 power cable

1. A utility pole that is formed with an organic material,
the utility pole comprising
a plurality of holes penetrating between an outside space and an internal space, the plurality of holes being formed in part of a side surface of a cylindrical trapezoid that has a thin upper portion and a thick lower portion.

2. The utility pole according to claim 1, wherein the plurality of holes is formed in an upper portion.

3. The utility pole according to claim 1, wherein an area density of the plurality of holes is higher in an upper portion than in a lower portion.

4. The utility pole according to claim 3, wherein the number of holes per unit area among the plurality of holes is constant, and a size of the plurality of holes is larger in an upper portion than in a lower portion.

5. The utility pole according to claim 3, wherein sizes of the plurality of holes are uniform, and the number of holes per unit area among the plurality of holes is larger in an upper portion than in a lower portion.

6. The utility pole according to claim 1, wherein some of the holes in an upper portion are circular holes.

7. The utility pole according to claim 6, wherein the some of the holes in the upper portion are circular holes of at least two different sizes.
